(19) United States
(12) Patent Application Publication
(10) Pub. No.: US 2004/0258508 A1
(43) Pub. Date: Dec. 23, 2004

(54) Method of filling bags with granular material

(76) Inventor: Glen Alvin Jewell, Athabasca (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/861,842

(22) Filed: Jun. 4, 2004

(30) Foreign Application Priority Data
Jun. 5, 2003 (CA) 2,431,281

(51) Int. Cl. B65G 65/00

(52) U.S. Cl. 414/328

(57) ABSTRACT

A method of filling bags with granular material. A motor vehicle is provided which is equipped with a bag support. A primary hopper is provided containing granular material. The primary hopper has a primary spout disposed over a motor vehicle loading position. A bag is coupled to the bag support of the motor vehicle. The motor vehicle is driven into the loading position. A valve is opened to initiate the flow of granular material from the primary hopper. The motor vehicle is then driven out of the loading position to an unloading position spaced from the primary hopper.

### FIELD OF THE INVENTION

The present invention relates to a method of filling bags with granular material, such as sand.

### BACKGROUND OF THE INVENTION

There are a number of applications in which it is desirable to rapidly fill bags with granular material. One example, is sand bags required for flood control. Another example, is pipeline weights filled with granular material, such as is disclosed in U.S. Pat. No. 6,220,788 (Jewell 2001).

U.S. Pat. No. 6,119,740 (Wilham Jr. et al 2000) entitled “Sand bag filler”, discloses an existing device for automatically filling sand bags with pre-measured quantities of sand.

### SUMMARY OF THE INVENTION

What is required is an alternative method of filling bags with granular material.

According to the present invention there is provided a method of filling bags with granular material. A first step involves providing at least one motor vehicle equipped with a bag support having means to support at least one bag with a mouth of the bag open in preparation for filling. A second step involves providing a primary hopper containing granular material and being adapted to deliver a pre-determined quantity of granular material so that over-filling is not of concern. The primary hopper has at least one primary spout disposed over a motor vehicle loading position. The at least one primary spout has a primary valve which has an open position to permit a flow of granular material from the primary hopper and a closed position. A third step involves providing means to selectively move the primary valve to the open position when the at least one motor vehicle is in the loading position. A fourth step involves coupling at least one bag to the bag support of the at least one motor vehicle. A fifth step involves driving the at least one motor vehicle into the loading position. A sixth step involves opening the primary valve to initiate the flow of granular material from the primary hopper. A seventh step involves driving the at least one motor vehicle out of the loading position to an unloading position spaced from the primary hopper.

With the method, as described above, large bags can be rapidly manoeuvred into an out of the loading position.

Although beneficial results may be obtained through the use of the method as described above, even more beneficial results may be obtained when a sensor is provided as the means to selectively move the primary valve to the open position when the at least one motor vehicle is in the loading position. The sensor is electronically coupled to the primary valve. The sensor monitors the loading position and moves the primary valve from the closed position to the open position when the at least one motor vehicle is sensed in the loading position. This means that the primary valve is open and granular material is flowing as soon as the motor vehicle comes to rest in the loading position.

Although beneficial results may be obtained through the use of the method, as described above, even more efficiencies may be obtained when more than one motor vehicle is provided. It is envisaged that each motor vehicle will take turns in the loading position. A first motor vehicle could be having a bag secured to its bag support, while a second motor vehicle is in the loading position filling its bag, while a third motor vehicle is in the unloading position.

Although beneficial results may be obtained through the use of the method, as described above, even more efficiencies may be obtained when an intermediate hopper is mounted on the motor vehicle. The intermediate hopper is disposed above the bag support. The intermediate hopper is filled from the primary hopper to minimize the time the motor vehicle must spend in the loading position. The intermediate hopper has at least one intermediate spout. The at least one intermediate spout has an intermediate valve with an open position to permit a flow of granular material from the intermediate hopper and a closed position.

Although beneficial results may be obtained through the use of the method, as described above, even more beneficial results may be obtained when a motor vehicle adapted with an intermediate hopper has more than one intermediate spout and means to support more than one bag on the bag support. This enables two, three or perhaps more bags being filled at once.

Although beneficial results may be obtained through the use of the method, as described above, when an intermediate hopper is used, and especially when there are several intermediate spouts attending several bags, even more beneficial results may be obtained when each intermediate spout has a flexible depending conduit adapted for insertion into the open mouth of the bag. This serves to reduce, if not eliminate, spillage. It will be understood why this can be beneficial when the intermediate hopper is being used to fill the bags, as the motor vehicle is in motion and travelling from the loading position to the unloading position.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a motor vehicle equipped with an intermediate hopper with depending conduits according to the teachings of the present invention.

FIG. 2 is a front elevation view of a motor vehicle loading position with a primary hopper.

FIG. 3 is a side elevation view of the motor vehicle with intermediate hopper illustrated in FIG. 1 situated for loading at the motor vehicle loading position with a primary hopper illustrated in FIG. 2.

FIG. 4 is a front elevation view of an intermediate hopper filling two bags.

FIG. 5 is a top plan schematic of multiple vehicles and multiple positions.

### DETAILED DESCRIPTION OF THE PREFERRED EMBODIMENT

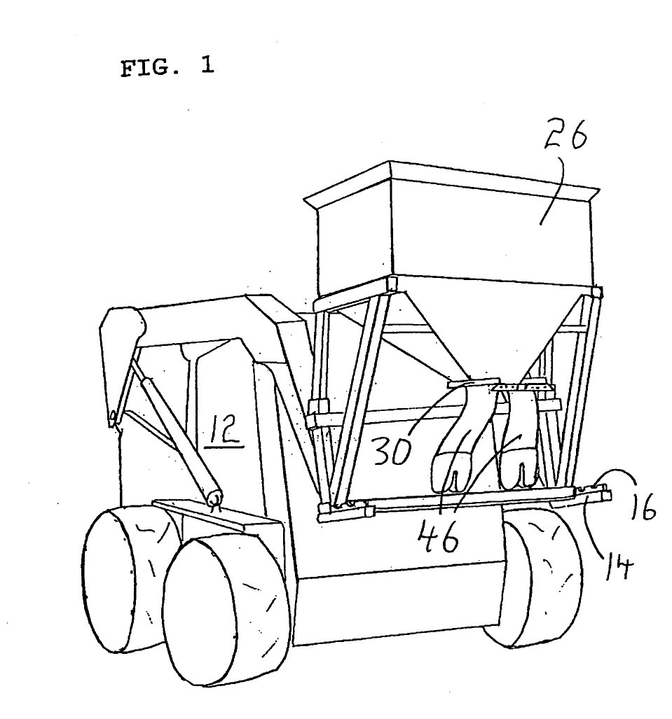

The preferred method of filling bags with granular material will now be described with reference to FIGS. 1 through 5.

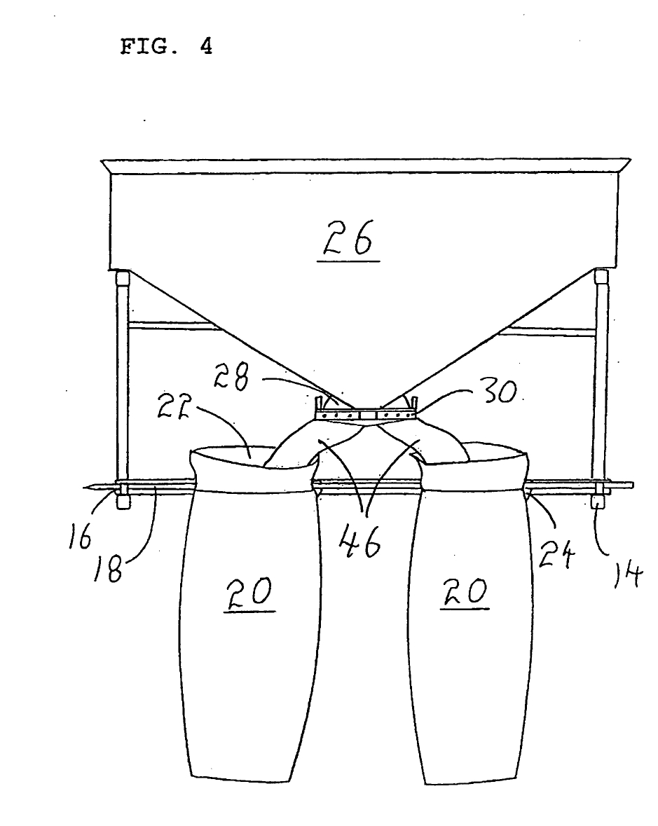

Referring to FIG. 1, a first step involves providing at least one motor vehicle 12 equipped with a bag support 14. In the illustrated embodiment, bag support 14 is adapted with notches 16. Referring to FIG. 4, notches 16 position a support bar 18 adapted to support at least one bag 20 such that mouth 22 of a bag 20 is open in preparation for filling. Each of bags 20 is adapted with a sleeve 24 into which support bar 18 is fitted, coupling bag 20 to bag support 14. It will be appreciated that other means of coupling bags 20 to bag support 14 may be used. Referring to FIG. 1, in the illustrated embodiment, an intermediate hopper 26 is mounted on the at least one motor vehicle 12. Intermediate hopper 26 is disposed above bag support 14. Referring to FIG. 4, intermediate hopper 26 is further adapted with at least one intermediate spout 28 for each bag 20. Each of intermediate spouts 28 is adapted with an intermediate valve 30 with an open position to permit a flow of granular material from the intermediate hopper and a closed position. Two intermediate spouts 28 with two intermediate valves 30 are illustrated. Intermediate hopper being is adapted to deliver a pre-determined quantity of granular material only sufficient to fill the bags 20 mounted on bag support 14 when intermediate valve 30 is in the open position, so over-filling is not of concern.

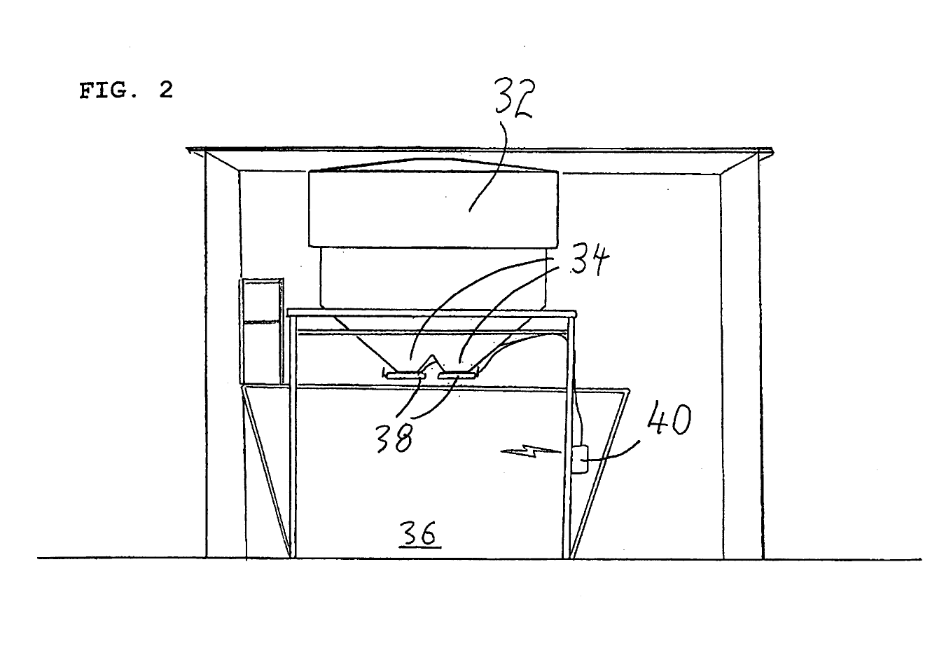

Referring to FIG. 2, a second step involves providing a primary hopper 32 containing granular material. In the illustrated embodiment, primary hopper 32 has two primary spouts 34 disposed over a motor vehicle loading position 36. Each primary spout 34 has a primary valve 38 which has an open position to permit a flow of granular material from the primary hopper and a closed position. Primary hopper 32 is adapted to deliver a pre-determined quantity of granular material only sufficient to fill intermediate hopper 26 when primary valve 38 is in the open position, so that over-filling is not of concern.

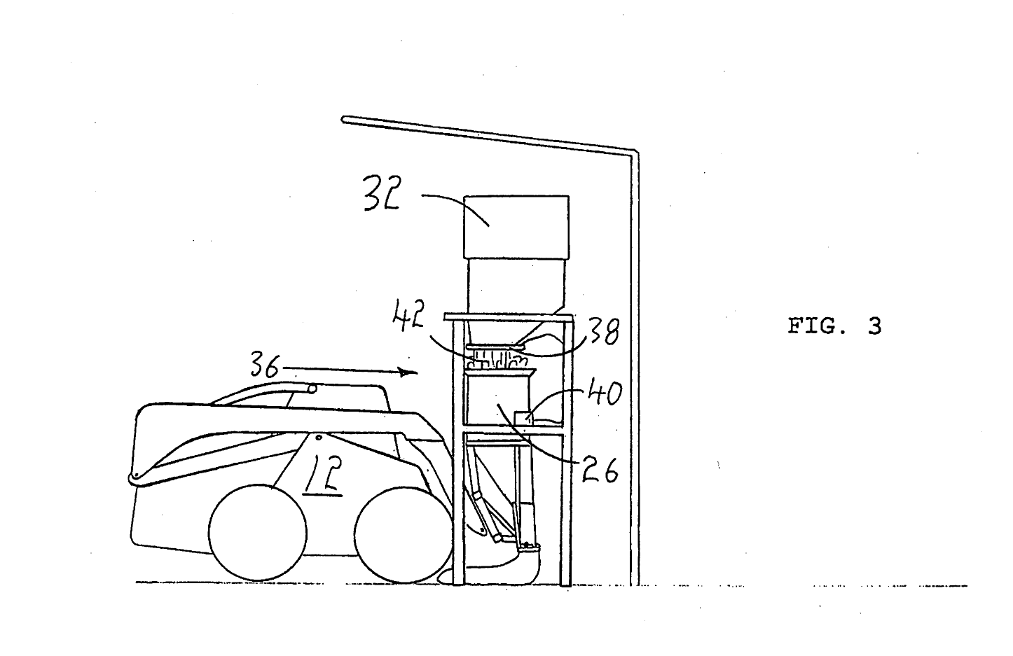

A third step involves providing a means to selectively move primary valve 38 to the open position when motor vehicle 12 is in loading position 36. In the illustrated embodiment, a sensor 40 is electronically coupled to primary valve 38 to selectively move primary valve 38 to the open position. Referring to FIG. 3, sensor 40 monitors loading position 36 and actuates primary valve 38 from the closed position to the open position when a motor vehicle 12 is detected in loading position 36.

Referring to FIG. 4, a fourth step involves coupling bags 20 to bag support 14 with support bar 18.

Referring to FIG. 3, a fifth step involves driving the motor vehicle 12 into loading position 36 tripping sensor 40.

A sixth step involves sensor 40 opening primary valve 38 to initiate the flow of granular material 42 from primary hopper 32 into intermediate hopper 26.

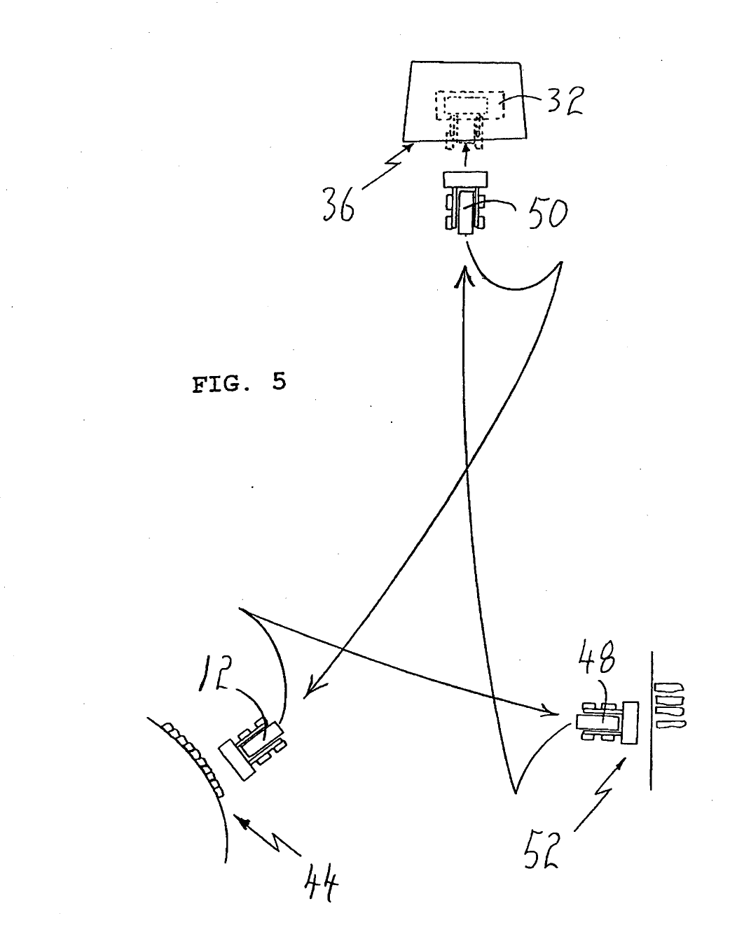

Referring to FIG. 5, a seventh step involves driving at least one motor vehicle 12 out of loading position 36 toward an unloading position 44 spaced from primary hopper 32. Referring to FIG. 4, while driving from loading position 36 to unloading position 44, intermediate valve 30 is activated to initiate a flow of granular material from intermediate hopper 26 into bags 20. Referring to FIGS. 1 and 4, in the illustrated embodiment, intermediate valves 30 are further adapted with depending conduits 46 allowing for a more efficient flow of granular material.

Referring to FIG. 5, in the illustrated embodiment, a first motor vehicle 12, a second motor vehicle 48 and a third motor vehicle 50 are provided. While first motor vehicle 12 is in an unloading position 44 unloading a finished bag for use, second motor vehicle 48 is in a fitting position 52 having a bag secured to its bag support and third motor vehicle 50 is in loading position 36 filling its bag. Where intermediate hoppers are used (as shown in FIG. 1), motor vehicles 12, 48 and 50 may fill their bags enroute, reducing the time duration of stops at loading position 36. Where all three motor vehicles move in a circuit, they make maximum use of both time and resources.

Variations

There is one change in the order to the outlined steps which gives equal, if not better results. Instead of attaching the bags to the secondary hopper prior to the secondary hopper being filled, the bags can be attached after the hopper is filled and then moved to the unloading position. Another variation is to fill the secondary hoppers with a front end loader, instead of using a primary hopper.

Cautionary Warnings:

It is preferred that “dry” granular material be used. It has been found that when the granular material is wet, clumping occurs which leads to bridging in the hoppers and gives inconsistent results.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A method of filling bags with granular material, comprising the steps of:
providing at least one motor vehicle equipped with a bag support adapted to support at least one bag with a mouth of the at least one bag open in preparation for filling;
providing a primary hopper containing granular material and being adapted to deliver a pre-determined quantity of granular material so that over-filling is not of concern, the primary hopper having at least one primary spout disposed over a motor vehicle loading position, the at least one primary spout having a primary valve which has an open position to permit a flow of granular material from the primary hopper and a closed position;
providing means to selectively move the primary valve to the open position when the at least one motor vehicle is in the loading position;
coupling at least one bag to the bag support of the at least one motor vehicle;
driving the at least one motor vehicle into the loading position;
opening the primary valve to initiate the flow of granular material from the primary hopper; and
driving the at least one motor vehicle out of the loading position to an unloading position spaced from the primary hopper.

2. The method as defined in claim 1, a sensor being provided as the means to selectively move the primary valve to the open position when the at least one motor vehicle is in the loading position, the sensor being electronically coupled to the primary valve, the sensor monitoring the loading position and moving the primary valve from the closed position to the open position when the at least one motor vehicle is sensed in the loading position.

3. The method as defined in claim 1, more than one motor vehicle being provided, with each motor vehicle taking turns in the loading position.

4. The method as defined in claim 1, an intermediate hopper being mounted on the at least one motor vehicle, the intermediate hopper being disposed above the bag support, the intermediate hopper being filled from the primary hopper to minimize the time the at least one motor vehicle must spend in the loading position, the intermediate hopper having at least one intermediate spout, the at least one intermediate spout having an intermediate valve with an open position to permit a flow of granular material from the intermediate hopper and a closed position.

5. The method as defined in claim 1, the bag support supporting more than one bag.

6. The method as defined in claim 4, the at least one intermediate spout having a flexible depending conduit adapted for insertion into the open mouth of the bag.

7. A method of filling bags with granular material, comprising the steps of:
providing at least one motor vehicle equipped with a bag support adapted to support more than one bag with a mouth of each bag open in preparation for filling, an intermediate hopper being mounted on the at least one motor vehicle, the intermediate hopper being disposed above the bag support, the intermediate hopper having an intermediate spout for each bag, the intermediate spouts having an intermediate valve with an open position to permit a flow of granular material from the intermediate hopper and a closed position, the intermediate hopper being adapted to deliver a pre-determined quantity of granular material only sufficient to fill the bags mounted on the bag support when the intermediate valve is in the open position, so over-filling is not of concern;
providing a primary hopper containing granular material, the primary hopper having at least one primary spout disposed over a motor vehicle loading position, the at least one primary spout having a primary valve which has an open position to permit a flow of granular material from the primary hopper and a closed position, the primary hopper being adapted to deliver a pre-determined quantity of granular material only sufficient to fill the intermediate hopper when the primary valve is in the open position, so that over-filling is not of concern;
providing a sensor to selectively move the primary valve to the open position when the at least one motor vehicle is in the loading position, the sensor being electronically coupled to the primary valve, the sensor monitoring the loading position and moving the primary valve from the closed position to the open position when the at least one motor vehicle is sensed in the loading position;
coupling bags to the bag support of the at least one motor vehicle;
driving the at least one motor vehicle into the loading position where the sensor initiates opening of the primary valve to initiate the flow of granular material from the primary hopper into the intermediate hopper; and
driving the at least one motor vehicle out of the loading position toward an unloading position spaced from the primary hopper while activating the intermediate valve to initiate a the flow of granular material from the intermediate hopper into the bags.

8. The method as defined in claim 7, more than one motor vehicle being provided, with each motor vehicle taking turns in the loading position.

9. The method as defined in claim 7, each intermediate spout having a flexible depending conduit adapted for insertion into the open mouth of one of the bags.

10. A method of filling bags with granular material, comprising the steps of:
providing at least one motor vehicle equipped with a bag support adapted to support at least one bag with a mouth of the at least one bag open in preparation for filling, a hopper being mounted on the at least one motor vehicle, the hopper being disposed above the bag support, the hopper having at least one spout, the at least one spout having a valve with an open position to permit a flow of granular material from the hopper and a closed position, the hopper being adapted to deliver a pre-determined quantity of granular material only sufficient to fill the at least one bag mounted on the bag support when the valve is in the open position, so over-filling is not of concern;
providing a primary source of granular material having a motor vehicle loading position;
coupling at least one bag to the bag support of the at least one motor vehicle;
driving the at least one motor vehicle into the loading position and filling the hopper with granular material; and
driving the at least one motor vehicle out of the loading position toward an unloading position, while activating the valve to initiate a flow of granular material from the hopper into the at least one bag.

11. A method of filling bags with granular material, comprising the steps of:
providing at least one motor vehicle equipped with a bag support adapted to support at least one bag with a mouth of the at least one bag open in preparation for filling, a hopper being mounted on the at least one motor vehicle, the hopper being disposed above the bag support, the hopper having at least one spout, the at least one spout having a valve with an open position to permit a flow of granular material from the hopper and a closed position, the hopper being adapted to deliver a pre-determined quantity of granular material only sufficient to fill the at least one bag mounted on the bag support when the valve is in the open position, so over-filling is not of concern;
providing a primary source of granular material having a motor vehicle loading position;
driving the at least one motor vehicle into the loading position and filling the hopper with granular material; and
coupling at least one bag to the bag support of the at least one motor vehicle and driving toward an unloading position, while activating the valve to initiate a flow of granular material from the hopper into the at least one bag.
